(19) United States
(12) Patent Application Publication
(10) Pub. No.: US 2024/0367417 A1
(43) Pub. Date: Nov. 7, 2024

(54) MULTILAYER FILM WITH ELECTRICALLY CONTROLLABLE OPTICAL PROPERTIES AND AT LEAST ONE ELECTRICAL CONTACT REGION

(71) Applicant: SAINT-GOBAIN GLASS FRANCE, Courbevoie (FR)

(72) Inventors: Florence JACQUES, Herzogenrath (DE); Nadine HECKER, Herzogenrath (DE); Alexandre FESSEMAZ, Herzogenrath (DE); Shawn IVES, Herzogenrath (DE)

(21) Appl. No.: 18/291,363

(22) PCT Filed: Aug. 12, 2022
(86) PCT No.: PCT/EP2022/072632

§ 371 Date: Jan. 23, 2024

(30) Foreign Application Priority Data
Sep. 8, 2021 (EP) 21195525.7

(51) Int. Cl. B32B 17/10; E06B 9/24; G02F 1/155

(52) U.S. Cl. CPC B32B 17/10513; B32B 17/10036; B32B 17/10807; G02F 1/155; B32B 2307/40; B32B 2605/00; E06B 9/24; E06B 2009/2464

(57) ABSTRACT

A multilayer film having electrically controllable optical properties. The multilayer film has a first carrier film, a first planar electrode, an active layer having one or more layers in sequence, a second planar electrode, and a second carrier film, arranged one above the other in a flat manner. In a contact region, the first carrier film, the first planar electrode, and the active layer are removed, such that the second planar electrode is exposed. The contact region is designed in the shape of a strip with tapered ends.

The invention relates to a multilayer film having electrically controllable optical properties, a method for producing the same and a laminated pane containing the same.

Glazings with electrically switchable optical properties are known. Such glazings contain a functional element, which typically contains an active layer or layer sequence between two planar electrodes. The optical properties of the active layer can be changed by a voltage applied to the planar electrodes. Electrochromic functional elements, known, for example, from US 20120026573 A1, WO 2010147494 A1, EP 1862849 A1 and WO 2012007334 A1 are an example of this. Another example are PDLC (polymer-dispersed liquid crystal) functional elements, which are known, for example, from DE 102008026339 A1. SPD functional elements (suspended particle device), known, for example, from EP 0876608 B1 and WO 2011033313 A1 are another example. The optical properties, which are electrically controlled, are in particular light transmission (as in the case of electrochromic or SPD functional elements) or light scattering (as in the case of PDLC functional elements). Glazings with such functional elements may be darkened electrically in a comfortable manner or provided with a high light diffusion.

Electrically switchable functional elements are often provided as multilayer films. In this case, the actual functional element is arranged between two polymeric carrier films. Such multilayer films enable the simplified production of electrically switchable glazing. Typically, the multilayer film is laminated between two glass panes using conventional methods, wherein a laminated pane with electrically switchable optical properties is created. In particular, the multilayer films may be purchased commercially such that the manufacturer of the glazing does not have to produce the switchable functional element itself.

Glazings with electrically controllable optical properties may be used, for example, as vehicle windows, the light transmission behaviour of which can then be controlled electrically. They can be used, for example, as roof panes to reduce exposure to direct sunlight or disruptive reflections. Such roof panes are known, for example, from DE 10043141 A1 and EP 3456913 A1. Windshields have also been proposed in which an electrically controllable sun screen is realised by a switchable functional element in order to replace the conventional mechanically foldable sun screen in motor vehicles. Windshields with electrically controllable sun screens are known, for example, from DE 102013001334 A1, DE 102005049081 B3, DE 102005007427 A1 and DE 102007027296 A1.

The carrier films are typically provided with electrically conductive coatings facing the active layer or layer sequence, which coatings act as planar electrodes. Such planar electrodes must be electrically contacted in order to connect them to a voltage source. This often involves removing at least one region of each carrier film, together with the planar electrode adhered thereto and the underlying active layer (sequence), in order to expose the planar electrode on the other carrier film, thereby providing a contact region. A current busbar can then be placed on this contact region, which is typically designed as a strip of copper film, and which in turn is connected to the voltage source via electrical cables.

To create the contact region, a cut is conventionally created in the relevant carrier film in order to separate the region to be removed from the surrounding regions. Said region typically has substantially the shape of the current busbar (with sometimes slightly increased dimensions), so it is strip-shaped in the shape of a rectangle. The region thus separated will then be peeled off. In this case, the problem often arises that delamination effects occur in the surrounding regions of the multilayer film due to the mechanical stress during peeling off. This can affect both the aesthetic appearance and the electrical function of the multilayer film.

The present invention is based on the object of providing an improved method for creating such a contact region, along with a correspondingly processed multilayer film. The method should be easy and gentle to carry out, such that in particular a delamination of the regions of the multilayer film surrounding the contact region may be avoided.

The object of the invention is achieved by a multilayer film with electrically controllable optical properties, at least comprising the following arranged in the specified order in a flat manner one above the other:
a) a first carrier film,
b) a first planar electrode,
c) an active layer or layer sequence with electrically controllable optical properties,
d) a second planar electrode and
e) a second carrier film.

According to the invention, in at least one region of the multilayer film, referred to as the contact region, the first carrier film, the first planar electrode, and the active layer or layer sequence are removed, such that the second planar electrode is exposed. According to the invention, said contact region is designed in the shape of a strip with tapered ends.

Said contact region of the multilayer film is more precisely referred to as the contact region of the second planar electrode within the context of the invention. It is used to make electrical contact with the second planar electrode, in order to connect it to an external voltage source. The first carrier film, the first planar electrode and the active layer (sequence) are completely removed there. Thus, the second planar electrode is exposed, i.e., no longer stored inside the multilayer film, but is freely accessible. More specifically, the surface of the second planar electrode facing away from the second carrier film is freely accessible in the contact region through the opening formed by removing the first carrier film, the first planar electrode and the active layer (sequence).

The object of the invention is also achieved by a method for producing a multilayer film with electrically switchable optical properties. In this case, a multilayer film with electrically controllable optical properties is first provided (method step A), which comprises at least two layers arranged in the specified order in a flat manner one above the other:
a) a first carrier film,
b) a first planar electrode,
c) an active layer or layer sequence with electrically controllable optical properties,
d) a second planar electrode and
e) a second carrier film.

Subsequently, at least one region of the first carrier film is separated from the surrounding regions of the first carrier film by a cut (method step B), wherein the cut surrounds a contact region in the shape of a strip with tapered ends. Then said region of the first carrier film is peeled off together with the region of the first planar electrode adhering to it, starting from such end (method step C). The second planar electrode is subsequently cleaned of any residues of the active layer or layer sequence.

The multilayer film and the method are described together below, wherein explanations and preferred designs relate equally to multilayer film and method. If preferred features are described in connection with the method, this means that the multilayer film is also preferably designed accordingly. If, on the other hand, preferred features are described in connection with the multilayer film, this means that the method is also preferably carried out accordingly.

The inventors have surprisingly found that the shape of the contact region according to the invention, i.e., the region in which the second planar electrode is exposed after the first carrier film, the first planar electrode and the active layer (sequence) have been removed, leads to significantly improved results. The first carrier film with the first planar electrode can be easily peeled off without delamination, i.e., separation of the individual layers of the multilayer film, occurring in the surrounding regions. In contrast, delamination effects occur to a much greater extent with other shapes of the contact region, for example the conventional rectangular shape or even oval shapes, in particular if the contact region is not adjacent to the side edge of the multilayer film in the edge region, but is spaced from it or is even located in a central region of the multilayer film. In this case, delamination effects are particularly likely due to the high mechanical stress when the first carrier film is detached. The multilayer film according to the invention thus opens up new areas of application or at least significantly simplifies their realisation. This is the major advantage of the present invention.

The multilayer film is a layer stack, wherein the layers of the layer stack comprise at least one first carrier film, a first planar electrode, an active layer or an active layer sequence, a second planar electrode and a second carrier film, which are arranged in this order in a flat manner one above the other. The layers of the layer stack are permanently connected to one another in a stable manner, for example by gluing or lamination. The multilayer film is thus provided as a prelaminated multilayer film, i.e., the carrier films, the planar electrodes and the active layer or layer sequence are already connected to form the multilayer film before the contact region is created by removing the region of the first carrier film and the associated regions of the first planar electrode and the active layer (sequence). Multilayer films of this type are typically commercially available and can be purchased, for example, through a glass manufacturer, cut to the required size and processed according to the invention. However, it is equally possible for the multilayer film to be produced by the company itself prior to processing.

According to the invention, the contact region, i.e., the exposed region of the second planar electrode or the distant region of the first carrier film, first planar electrode and active layer (sequence), is strip-shaped in top view with tapered ends. In this case, a strip is understood to be an elongated shape the length of which is greater than its width, in particular at least twice as great as the width, preferably at least three times as great, particularly preferably at least five times as great.

The contact region is limited by an outline or boundary line. The cut created in the first carrier film in the method according to the invention (method step B) runs along such boundary line. In this case, the cut is created along (at least) one cutting line that (at least partially) coincides with the boundary line. If the contact region is directly adjacent to the side edge of the multilayer film, a section of the boundary line coincides with a section of the side edge. Of course, there is no need to create a cut there. The cutting line then runs from the side edge back to the side edge of the multilayer film. If, on the other hand, the contact region is spaced from the side edge, the cutting line is circumferential and corresponds at least to the boundary line. In both cases, the cutting line may extend beyond the boundary line to create additional cuts that later do not coincide with the boundary line of the contact region, but remain as cuts in the first carrier film adjacent to the contact region. The cut may be created along a single cutting line corresponding to the boundary line (or a portion thereof if the contact region is directly adjacent to a side edge of the multilayer film). However, the cut may also be created along a plurality of cutting lines, which touch or intersect one another.

The ends of the strip are understood to be the regions between which the length dimension of the strip extends. The strip thus extends from one end to the other. The tapered ends are limited by two non-parallel sections of the boundary line of the contact region that touch at a point (the end point of the tapered region, the actual tip). In the tapered ends (in other words, in the region of the tapered ends), the width of the strip decreases continuously up to the end point.

In an advantageous design, the strip-shaped contact region is designed to be symmetrical, more precisely mirror-symmetrical with respect to the central axis in the longitudinal dimension, such that the end points of the tapered ends lie on such central axis. This applies in particular to the case where the contact region is spaced from the side edge of the multilayer film.

In a preferred design, the contact region is designed in the shape of an elongated hexagon. Two opposite, parallel sides of the hexagon form the lateral boundaries of the contact region in its direction of extension (length dimension). The two end points of such two sides are each connected to one another by two further sides, which together each form a tapered end of the contact region. The hexagon can be thought of as a rectangle, as it were, with two triangles attached to opposite side edges, wherein the triangles form the tapered ends. With the hexagonal shape, very good results are achieved in terms of avoiding delamination. In addition, common current busbars (in particular, substantially rectangular strips of electrically conductive film) can be readily inserted into such a contact region, because the shape of the central rectangular region of the hexagon (limited by said two opposite parallel sides extending in the longitudinal dimension) is adapted to the shape of the current busbar. Due to the straight side boundary sections, the hexagonal shape is well suited if the contact region is to be directly adjacent to the (typically straight) side edge of the multilayer film.

However, the contact region may also be realised by other forms. For example, it may be lenticular, consisting of two curved lines that touch one another twice. The two points of contact of the curved lines form the end points of the tapered ends.

The hexagonal and lenticular designs of the contact region are preferably mirror symmetrical with respect to the central axis in the length dimension. However, this is not mandatory.

In a further design of the invention, the contact region is not mirror symmetrical with respect to the central axis in the length dimension. This applies in particular to the case where the contact region is directly adjacent to a side edge of the multilayer film. In a preferred design, the contact region is designed in the shape of a trapezoid, particularly preferably in the shape of an isosceles trapezoid. The trapezoid has two long sides (base sides) arranged substantially parallel to one another and extending in the length dimension of the strip-like contact region, and two short sides. The two long sides are of different lengths, and the longer of the two base sides is also called the base of the trapezoid. The endpoints of the tapered ends are the corners that connect the base to the two adjacent short sides. The trapezoidal shape is also ideal for using what is substantially a rectangular-strip-shaped current busbar.

A further design of the contact region, which is not mirror symmetrical with respect to the central axis in the longitudinal dimension, is the shape of a parallelogram. The parallelogram has two substantially parallel long sides and two substantially parallel short sides that connect the long sides. The end points of the tapered ends are the terminal corners that connect a long side to the adjacent short side, wherein the angle between the long and short sides is less than 90°. In a parallelogram, the two corners that form said endpoints are arranged on different long sides, while in a trapezoid they are arranged on the same long side (base).

The trapezoidal shape is particularly preferred if the contact region is directly adjacent to a side edge of the multilayer film and extends along this such edge. In this case, the base of the trapezoid coincides with a section of the side edge. The cutting line along which the cut is created through the first carrier film then does not include the base of the trapezoid, but starts from the side edge of the multilayer film, includes the first short side, the shorter long side and the second short side, and runs back to the side edge of the multilayer film. The end points of the tapered ends lie on the side edge of the multilayer film. The hexagonal shape is particularly preferred if the contact region is spaced from the side edge of the multilayer film.

The tapered ends of the contact region are limited by two touching sections of the boundary line of the contact region, as described. In an advantageous design, such sections enclose an angle smaller than 90°, preferably from 50° to exclusively 90°, in particular between 50° and 90°. Particularly good results are achieved thereby.

In a preferred embodiment of the method, the tapered ends are each limited by two touching sections of the boundary line of the contact region, wherein a cut is made as an extension of each of said sections at least in the first carrier film. The cutting lines (or terminal cutting line sections) thus continue beyond the point of contact. After the first carrier film in the contact region is removed, a portion of such cutting line sections (up to the point of intersection) in each case forms a section of the boundary line of the contact region. The portion of each cutting line section extending beyond the point of intersection remains as a cut in (at least) the first carrier film. Thus, at each end point of the contact region, two cuts are made in the first carrier film along which the carrier film is severed. These two cuts start from the relevant end point of the contact region and form extensions of the sections of the boundary line of the contact region adjacent to the end point. This has been shown to be particularly advantageous for gently cutting off and removing the first carrier film in the contact region and avoiding delamination. The length of the cuts (starting from the end point of the tapered ends or from the point of intersection of the cutting line sections) is preferably at least 1 mm, more preferably from 1 mm to 5 mm, most preferably from 1.5 mm to 3 mm. Cut lengths in this range ensure gentle removal of the first carrier film in the contact region, without the cuts being too visually noticeable. The cutting lines continuing beyond the end points of the tapered end regions cannot, of course, be used if they lie on the side edge of the multilayer film, as is the case, for example, with a trapezoidal shape the base of which coincides with the side edge.

Preferably, in the contact region with the exposed second planar electrode, a current busbar (busbar) is arranged on the second planar electrode and electrically conductively connected to it. The current busbar can be easily laid on, soldered to the planar electrode or connected to the planar electrode via a conductive adhesive. It is also possible to insert the current busbar into the contact region, as it were, such that regions of the current busbar extend under the surrounding first carrier film, thereby fixing the busbar in place.

The current busbar is used for the electrical contacting of the planar electrode. It is designed to be connected to a voltage source via electrical cables to apply an electrical potential to the planar electrode. It is preferably takes designed in the shape of a strip of an electrically conductive film, for example a copper film. The width of the busbars is preferably from 1 mm to 10 mm, for example approximately 5mm. The thickness of the busbars is preferably from 50 μm to 200 μm, for example approximately 90 μm.

To ensure the functionality of the electrically controllable multilayer film, the first planar electrode must also be electrically contacted. In principle, it is conceivable that only the second planar electrode is contacted in a contact region formed according to the invention, while the first planar electrode is contacted in a conventional manner. Preferably, however, the multilayer film also has a contact region for the first planar electrode in accordance with the invention. The multilayer film then has at least one further contact region in which the second carrier film, the second planar electrode and the active layer or layer sequence are removed, such that the first planar electrode is exposed. This further region (contact region for the first planar electrode), like the contact region of the second planar electrode, in top view is designed in the shape of a strip with tapered ends.

The preceding statements regarding the contact region of the second planar electrode according to the invention apply, independently of this, also to the contact region of the first planar electrode, if this is also designed according to the invention. Preferably, the at least one contact region of the first planar electrode is formed identically to the at least one contact region of the second planar electrode.

In one design of the invention, the contact region is directly adjacent to the side edge of the multilayer film and, in particular, extends parallel to such side edge (that is, the longitudinal dimension of the contact region is arranged substantially parallel to the side edge). However, in a particularly advantageous design, the contact region is spaced from the side edges of the multilayer film, such that it is completely surrounded by the rest of the multilayer film. In this design as well, the contact region preferably extends parallel to a side edge. Since the removed region of the carrier film is completely surrounded by other regions of the carrier film, particularly strong mechanical stresses occur during removal, and delamination effects are particularly likely. The design of the contact regions according to the invention, which reduces the probability of such delamination effects, has a particularly positive effect here. It is also possible for the multilayer film to have a plurality of contact regions, some of which are directly adjacent to the side edge and others of which are spaced therefrom. If a contact region is spaced from the side edges, it may be arranged in the edge region with a small distance of a few millimetres or centimetres. However, it can also have a large distance to the side edges, for example running substantially centrally between two opposite side edges, in order to accelerate the switching behaviour of the multilayer film.

In a particularly preferred design, a plurality of contact regions for the second planar electrode and contact regions for the first planar electrode are arranged one behind the other along a line. The length dimension of the contact regions is aligned along this line and the contact regions are arranged such that contact regions for the second planar electrode and contact regions for the first planar electrode alternate. The result is a meander-like electrical contact, as it were, wherein one current busbar of the second planar electrode and one current busbar of the first planar electrode are arranged alternately linearly one behind the other. As a result, more rapid switching behaviour when the optical properties change may be achieved. This is particularly advantageous for electrochromic multilayer films, because these typically tend to have comparatively slow switching behaviour. Said line is preferably arranged parallel to at least one side edge of the multilayer film. Said line is most preferably a circumferential line that extends in the edge region along the entire side edge of the multilayer film. A distance of a few millimetres to 1 cm may be provided between adjacent contact regions. The contact regions on said line may be directly adjacent to or spaced from the side edge of the multilayer film. The thickness of the intermediate layer is preferably from 2.5 cm to 10 cm, particularly preferably from 3 mm to 10 mm.

The active layer or layer sequence has the variable optical properties which can be controlled by a voltage applied to the active layer via the planar electrodes. By applying a voltage to the planar electrodes, or by changing the voltage applied to the planar electrodes, the optical properties of the active layer or layer sequence can be controlled. The variable optical properties relate in particular to the degree of light transmission and/or the degree of light scattering, wherein, within the context of the invention, light is understood in particular to mean visible light in the spectral range of from 380 nm to 780 nm. In the context of the invention, electrically controllable optical properties are understood, in particular, to mean such properties which are continuously controllable. In the context of the invention, the switching state of the multilayer film means the extent to which the optical properties are changed compared to the voltage-free state. A 0% switching state corresponds to the voltage-free state while a 100% switching state corresponds to the maximum change in optical properties. Between the two aforementioned states, all switching states can be continuously realised by selecting the voltage accordingly. A switching state of 20% corresponds, for example, to a change in the optical properties by 20% of the maximum change. Said optical properties relate in particular to the light transmission and/or the scattering behaviour. In principle, however, it is also conceivable that the electrically controllable optical properties can only be switched between two discrete states. In that case, only two switching states exist—namely 0% and 100%. It is also conceivable that the electrically controllable optical properties can be switched between more than two discrete states.

The two planar electrodes and the active layer or layer sequence located in between form the actual electrically controllable functional element of the multilayer film according to the invention, which is protected and stabilised by the carrier films. The functional element can, in principle, be any functional element having electrically controllable optical properties known per se to the person skilled in the art. The design of the active layer or layer sequence depends on the type of functional element.

In a particularly preferred design, the multilayer film according to the invention is an electrochromic multilayer film, and the functional element is an electrochromic functional element. Electrochromic functional elements contain an active layer sequence between the planar electrodes (electrochromic layer sequence). The active layer or layer sequence according to the invention is thus an electrochromic active layer sequence. The active layer sequence comprises the following arranged in a flat manner one above the other in the order indicated:
an ion storage layer,
an electrolyte layer, and
an electrochromic layer.

The electrochromic layer is the actual bearer of the electrically controllable optical properties. It is an electrochemically active layer whose degree of light transmission is dependent on the degree of ion storage. The ions (for example H⁺—, Li⁺, Na⁺— or K⁺ ions) are stored in and provided by the ion storage layer. The electrolyte layer separates the electrochromic layer spatially from the ion storage layer and serves to migrate ions. If a DC voltage of suitable polarity is applied to the planar electrodes, ions will migrate from the ion storage layer, through the electrolyte layer and into the electrochromic layer, whereupon the optical properties (colour, light transmission) of the electrochromic layer are changed depending on the quantity of ions that have migrated into said layer. If DC voltage of the opposite polarity is applied to the planar electrodes, the ions will migrate from the electrochromic layer, through the electrolyte layer and back into the ion storage layer and the optical properties of the electrochromic layer change in the opposite manner. If no voltage is applied to the planar electrodes, the current state will remain stable. Suitable electrochromic layers contain electrochromic materials, for example inorganic oxides (such as tungsten oxide or vanadium oxide), complex compounds (such as Prussian blue) or conductive polymers (such as 3,4-polyethylenedioxythiophene (PEDOT) or polyaniline). Electrochromic functional elements are known, for example, from WO 2012007334 A1, US 20120026573 A1, WO 2010147494 A1, and EP 1862849 A1. The electrolyte layer is typically designed as a film of organic or inorganic, electrically insulating material with a high degree of ion conductivity, for example based on lithium phosphorus oxynitride. The ion storage layer is either permanently transparent (pure ion storage) or has electrochromic behaviour opposite that of the electrochromic layer. One example of pure ion storage is layers containing a mixed oxide of titanium and cerium; examples of anodically electrochromic ion storage layers are layers containing iridium oxide or nickel oxide.

It has been shown that electrochromic multilayer films are particularly susceptible to delamination effects when the carrier films are removed in regions to create contacting regions. The method according to the invention, with which the carrier films are removed so gently that delamination can be avoided, is therefore particularly advantageous for electrochromic multilayer films.

However, the invention may also be applied to other multilayer films, for example PDLC multilayer films or SPD multilayer films.

With PDLC multilayer films, the functional element is a PDLC (polymer dispersed liquid crystal) functional element. PDLC functional elements contain an active layer between the planar electrodes. The active layer or layer sequence according to the invention is thus designed as an active layer in this case. The active layer is a PDLC layer and contains liquid crystals which are embedded in a polymer matrix. PDLC functional elements are typically operated using AC voltage. If no voltage is applied to the planar electrodes, the liquid crystals will be aligned in a unordered manner, which results in strong scattering of the light passing through the active layer. If a voltage is applied to the planar electrodes, the liquid crystals will align in a common direction and the transmission of light through the active layer is increased. Such a functional element is known, for example, from DE 102008026339 A1. The term PDLC is to be interpreted broadly within the context of the invention and includes related functional elements which are based on the alignment of liquid crystals, for example PNLC (polymer-networked liquid crystal) functional elements.

With SPD multilayer films, the functional element is an SPD (suspended particle device) functional element. SPD functional elements contain an active layer between the planar electrodes. The active layer contains suspended particles that are preferably embedded in a viscous matrix. The absorption of light by the active layer can be varied by applying a voltage on the planar electrodes, which results in a change in orientation of the suspended particles. Such functional elements are known, for example, from EP 0876608 B1 and WO 2011033313 A1.

The planar electrodes are provided to be electrically connected to at least one external voltage source. The planar electrodes are preferably transparent, which in the context of the invention means that they have a light transmission in the visible spectral range of at least 50%, preferably at least 70%, particularly preferably at least 80%. The planar electrodes are in particular electrically conductive thin layers or thin-layer stacks. The planar electrodes preferably contain at least one metal, a metal alloy or a transparent conducting oxide (TCO). The planar electrodes particularly preferably contain at least one transparent conductive oxide. The planar electrodes can, for example, be based on silver, gold, copper, nickel, chromium, tungsten, indium tin oxide (ITO), gallium-doped or aluminium-doped zinc oxide and/or fluorine-doped or antimony-doped tin oxide, preferably based on silver or ITO. The planar electrodes preferably have a thickness of 10 nm to 2 μm, particularly preferably of 20 nm to 1 μm, very particularly preferably of 30 nm to 500 nm, and in particular of 50 nm to 200 nm. If a thin layer is based on a material, this means within the context of the invention that the layer consists largely of the material (more than 50 wt. %, preferably more than 90 wt. %, in particular more than 99 wt. %), wherein the layer can contain small amounts of other materials, for example dopings.

The carrier films preferably contain at least one thermoplastic polymer or are based thereon, particularly preferably polyethylene terephthalate (PET), polypropylene, polyvinyl chloride, fluorinated ethylene propylene, polyvinyl fluoride or ethylene tetrafluoroethylene, very particularly preferably PET. This is particularly advantageous with regard to the stability of the multilayer film. The thickness of each carrier film is preferably from 0.1 mm to 1 mm, particularly preferably from 0.1 mm to 0.5 mm, in particular from 0.1 mm to 0.2 mm. On the one hand, a low thickness of the glazing in which the multilayer film is to be used is advantageously achieved by carrier films having such a low thickness. On the other hand, effective protection of the active layer and of the electrically conductive layers is ensured. If a polymeric layer is formed on the basis of a material, this means within the context of the invention that the layer consists largely of the material (more than 50% by weight), although the layer may contain other materials, for example plasticizers, stabilisers or UV blockers.

Polymer films with an electrically conductive coating are typically used, wherein the coating forms the associated planar electrode. ITO-coated PET films are particularly common. The adhesion between the carrier film and the planar electrode is thus very strong, which is advantageous for the method according to the invention, because when the region of the carrier film is removed (method step C), the planar electrode remains adhered and is removed together with the carrier film. Clean and easy removal of the planar electrode in the contact region can be facilitated by the fact that in method step B the cut is made not only in the carrier film, but also in the planar electrode.

In method step (B), a cut is made in the first carrier film in order to remove it in the contact region. Preferably, the cut is made not only in the first carrier film, but also in the first planar electrode. Then, the region of the first carrier film can be cleanly removed together with the region of the first planar electrode adhering to it. It is optionally possible for the cut to continue into the active layer or layer sequence as well.

In an advantageous embodiment of the method according to the invention, in method step (B) the cut is created by the radiation of a laser. Laser processing can be performed more rapidly and gently than, for example, mechanical processing such as cutting with a blade. The inventors have found that the carrier film in the contact region can be removed very easily and gently without delamination effects if the region of the carrier film to be removed is separated from the surrounding regions by laser cutting.

The radiation of the laser is directed onto the multilayer film, wherein the first carrier film to be cut preferably faces the laser. It irradiates the first carrier film in order to cut it. The laser beam is moved along one or more cutting lines for this purpose. The cutting line (or the sum of all cutting lines) corresponds to the boundary line (outline) of the contact region to be created, i.e., the region of the first carrier film to be removed, unless the contact region is to be formed adjacent to the side edge of the multilayer film, such that a section of the boundary line coincides with a section of the side edge and does not require a cutting line. Alternatively, the cutting lines include but extend beyond such boundary line. This is particularly true in the case where cuts are to be made in the carrier film that continue beyond the tapered ends of the contact region.

The radiation of the laser is preferably focused on the multilayer film by means of at least one optical element, for example a lens or objective, in particular on the (first) carrier film facing the laser. F-theta lenses or f-theta objectives are particularly suitable. These result in the foci of the laser radiation being arranged in one plane at different exit angles and enable a constant speed of movement of the laser radiation across the multilayer film.

The focal length of the focusing element determines the extension of the focus of the laser radiation. The focal length of the focusing optical element is preferably from 2 cm to 20 cm, more preferably from 3 cm to 5 cm. Particularly good results are achieved thereby. A smaller focal length of the optical element requires a working distance between the multilayer film and the optical element that is too small. A larger focal length will cause the laser focus to expand too much, limiting the resolving power of the cutting method and the output density at the focus.

If a region of the second carrier film is also to be removed in order to create a contact region for the first planar electrode in accordance with the invention, the method is repeated, wherein the second carrier film faces the laser accordingly and the laser radiation is focused on the second carrier film.

Between the laser and the focusing optical element, the radiation of the laser can be guided by at least one optical fibre, such as a glass fibre. Other optical elements may also be arranged in the beam path of the laser, for example collimators, apertures, filters or elements for frequency doubling.

The cut is created by moving the radiation of the laser relative to the multilayer film. In an advantageous embodiment, the multilayer film is stationary in this case and the radiation of the laser is moved over the carrier film. The movement of the radiation of the laser is preferably performed by at least one mirror, which is connected to a movable component. The movable component allows the mirror to be tilted in two directions, preferably two mutually orthogonal directions, particularly preferably horizontally and vertically. The movement of the radiation of the laser may also be performed by a plurality of mirrors, each connected to a movable component. For example, the movement of the radiation of the laser may be performed by two mirrors, wherein one mirror may be tilted in the horizontal direction and the other mirror may be tilted in the vertical direction. Alternatively, the movement of the radiation of the laser can be performed by a movement of the focusing element and the laser or by a movement of the focusing element and an optical fibre across the stationary multilayer film. Alternatively, the radiation of the laser may be stationary and the multilayer film may be moved to insert the isolation line.

The wavelength of the laser radiation should be selected so that the carrier film has a sufficiently high absorption to the laser radiation. By focusing the laser radiation on the first carrier film and/or by a suitable selection of the laser output, it can be prevented that not only the (first) carrier film facing the laser is cut, but also the (second) carrier film facing away from the laser is cut.

The wavelength is preferably in the mid-infrared (IR) range from 3 μm to 50 μm, more preferably from 5 μm to 20 μm, most preferably from 8 μm to 15 μm. This achieves good results with common carrier films, particularly those made of PET. In an advantageous embodiment, a CO₂ laser is used with a wavelength of 10.6 μm. However, in principle, other laser types, for example solid-state lasers with suitable crystals or diodes as the active medium, may be used.

The output power of the radiation of the laser is preferably from 1 W to 50 W, particularly preferably 5 W to 20 W, in particular from 8 W to 12 W. The required output power depends in particular on the wavelength of the laser radiation used and the degree of absorption of the carrier film and may be determined by the person skilled in the art by simple experiments. With outputs in the specified range, good results are achieved with common carrier films.

The radiation of the laser is preferably moved over the multilayer film at a speed of 0.5 m/s to 20 m/s, more preferably from 1 m/s to 10 m/s, most preferably from 3 m/s to 5 m/s. This is advantageous in terms of time-saving processing with complete separation of the first carrier film.

In a preferred embodiment, the laser is operated in pulsed mode. This is particularly advantageous in terms of high output density and effective insertion of the cut. The pulse frequency is preferably from 100 Hz to 10,000 Hz, more preferably from 500 Hz to 5000 Hz, most preferably from 1000 Hz to 3000 Hz. This is particularly advantageous with regard to the output density of the laser during laser structuring. The pulse length is preferably in the microsecond range and is, for example, from 10 μs to 100 μs.

After the carrier film has been cut, in method step (C) the cut-out region of the first carrier film is removed together with the associated region of the first planar electrode. To this end, one of the two tapered ends of the strip-shaped region is lifted and the region of the first carrier film is peeled off starting from such end. For this purpose, a thin blade, for example a razor blade, is preferably used.

When the region of the first carrier film is peeled off, it may happen that a portion of the active layer or layer sequence also remains attached to the first carrier film and is removed with it. However, often at least a portion of the active layer or layer sequence, if not the entire active layer or layer sequence, remains in the multilayer film. In order to expose the second planar electrode, it is necessary in this case that, in the contact region, the second planar electrode is cleaned of the residues of the active layer or layer sequence in method step (D).

The residues of the active layer or layer sequence are preferably removed with an organic solvent. Ethanol, acetone or isopropanol are particularly preferred. Surfactants may be added to the organic solvent. It has been shown that good results are achieved with commercially available glass cleaners, grease solvents or industrial surface cleaners.

It is particularly advantageous if the solvent is applied to the contact region and can act there to dissolve the residues of the active layer or layer sequence from the second planar electrode. The exposure time is preferably at least 1 s, particularly preferably at least 2 s, for example from 1 s to 60 s, most preferably from 2 s to 10 s. The solvent can then easily be wiped off together with the residues of the active layer (sequence), preferably with a lint-free cloth, such as is also used for cleaning eyeglasses or other lenses.

In a preferred embodiment, after the second planar electrode has been cleaned, a current busbar is applied to it and electrically conductively connected to it, for example laid on, glued on or soldered on.

After the contact region according to the invention has been created, preferably in a further method step, a current busbar is attached in an electrically conductive manner to the now exposed second planar electrode.

If a contact region according to the invention is also to be created for the first planar electrode, the method is carried out accordingly, wherein the second carrier film is cut up and removed in regions. The previous statements apply accordingly. A current busbar is also preferably subsequently attached to the first planar electrode.

The side edge of the multilayer film can be sealed, for example by fusing the carrier films or by a (preferably polymeric) tape. The active layer can thus be protected, in particular from components (in particular plasticizers) of the intermediate layer of a laminated pane in which the multilayer film is embedded diffusing into the active layer, which can lead to degradation of the functional element.

In addition to the active layer or layer sequence, the planar electrodes and the carrier films, the multilayer film may, of course, have other layers known per se, for example barrier layers, blocker layers, anti-reflective or reflective layers.

The invention also comprises the use of a multilayer film according to the invention in glazing, in particular laminated panes, in buildings, for example in the access or window region, or in means of transport for land, air or water traffic, in particular in trains, ships, aircraft and motor vehicles, for example as a windshield, rear pane, side pane and/or roof pane.

The invention further comprises a laminated pane, wherein at least one multilayer film according to the invention is arranged between two panes in a planar manner. The multilayer film is preferably embedded in the intermediate layer of the laminated pane. For this purpose, each carrier film is preferably connected to one of the panes via at least one thermoplastic connecting film. The thermoplastic connecting films contain at least one thermoplastic polymer, for example ethylene vinyl acetate (EVA), polyvinyl butyral (PVB) or polyurethane (PU), particularly preferably PVB. The thickness of the thermoplastic connecting films is preferably from 0.25 mm to 2 mm, for example, the standard thicknesses of 0.38 mm or 0.76 mm. The two aforementioned connecting films on both sides of the multilayer film preferably project circumferentially beyond the multilayer film. Particularly preferably, the side edges of the multilayer film are surrounded circumferentially by a frame-like third thermoplastic connecting film. This has a recess into which the multilayer film is inserted.

The panes are preferably made of glass, particularly preferred soda-lime glass, or rigid clear plastics, for example polycarbonate (PC) or polymethyl methacrylate (PMMA). The panes can be clear and transparent or also tinted or coloured. The thickness of the panes can vary widely and therefore be adapted to the requirements of the individual case. The thickness of each pane is preferably from 0.5 mm to 15 mm, particularly preferably from 1 mm to 5 mm. The laminated pane can have any three-dimensional shape. The laminated pane is preferably flat or slightly or strongly curved in one direction or in a plurality of spatial directions.

The laminated pane may be produced by stacking at least the first pane, the first thermoplastic connecting film, the multilayer film having electrically controllable optical properties according to the invention, the second thermoplastic connecting film, and the second pane in this order and laminating them to form the laminated pane. Known methods, for example autoclave methods, vacuum bag methods, vacuum ring methods, calender methods, vacuum laminators or combinations thereof, may be used for this purpose. The connection of the panes via the intermediate layer (made of thermoplastic connecting films and multilayer film) is usually performed under the action of heat, vacuum and/or pressure.

The invention is explained in more detail with reference to a drawing and exemplary embodiments. The drawing is a schematic representation and is not true to scale. The drawing does not limit the invention in any way. In the figures:

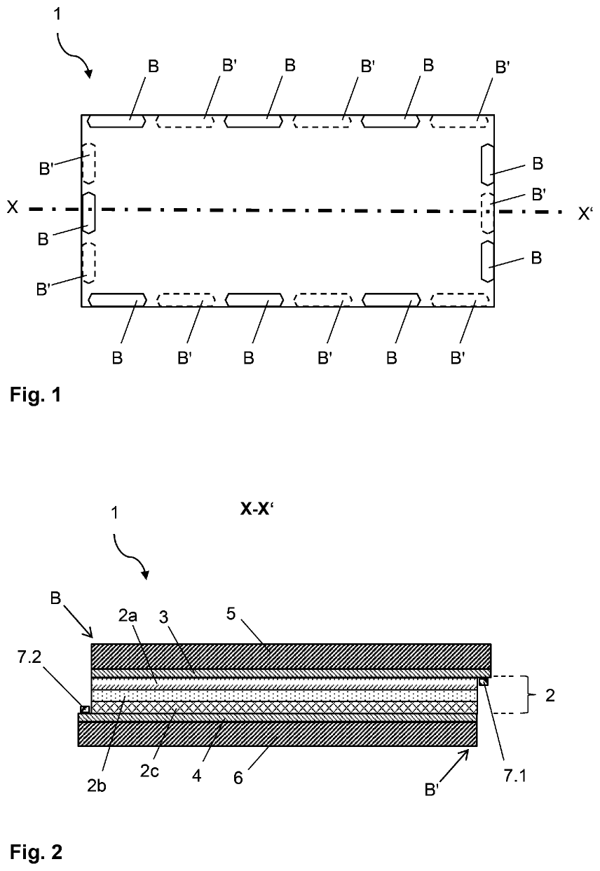

FIG. 1 shows a top view of a design of a multilayer film according to the invention,

FIG. 2 shows a cross section along X-X′ through the multilayer film according to FIG. 1,

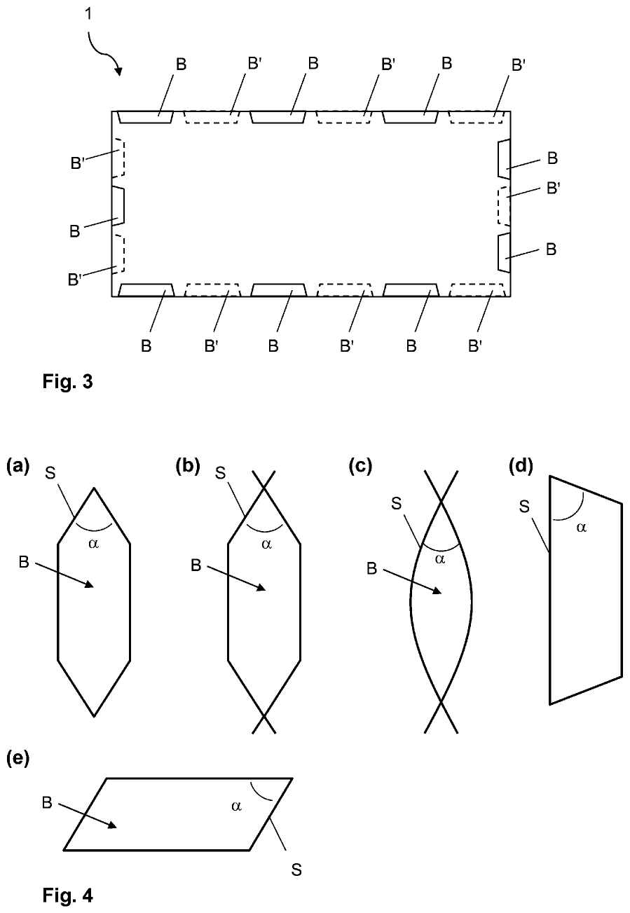

FIG. 3 shows a top view of a further design of a multilayer film according to the invention

FIG. 4 shows a top view of various designs of the invention of the cutting line in the first carrier film and the contact region created thereby,

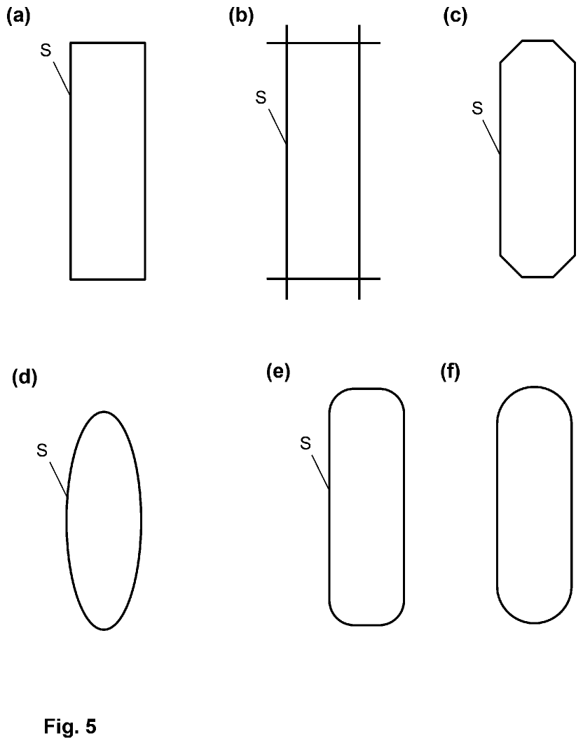

FIG. 5 shows a top view of various designs of the cutting line in the first carrier film not according to the invention and the contact region created thereby as comparative examples,

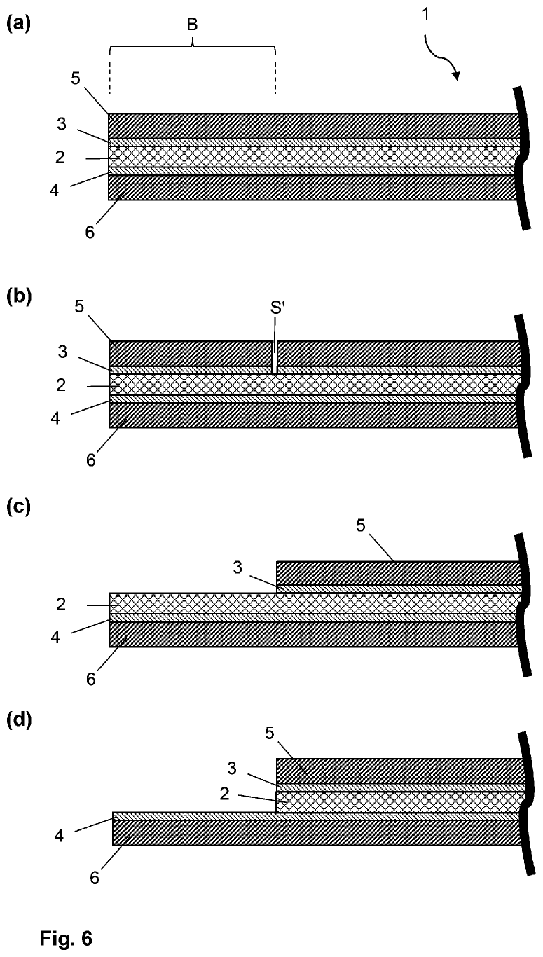

FIG. 6 shows cross sections through a multilayer film at various points in time during the method according to the invention,

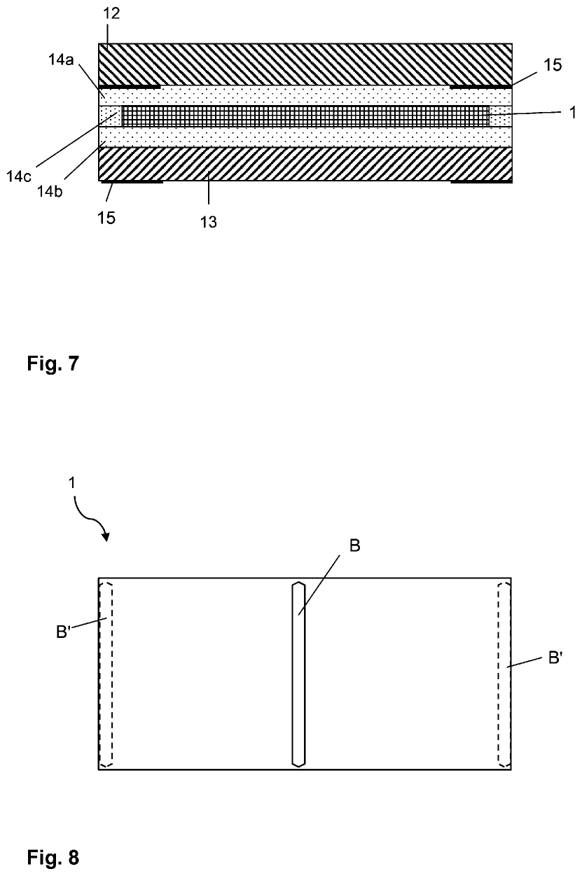

FIG. 7 shows a cross section through a laminated pane containing a multilayer film according to the invention,

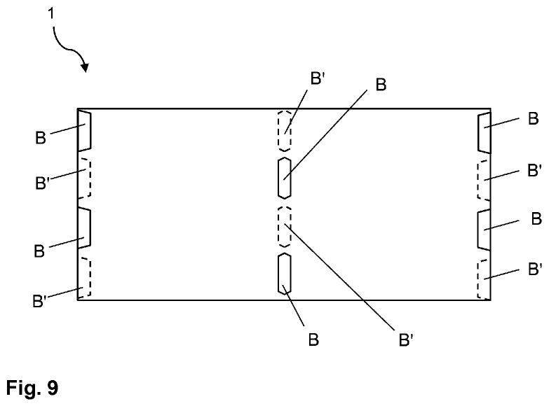

FIG. 8 shows a top view of a further design of a multilayer film according to the invention, and

FIG. 9 shows a top view of a further design of a multilayer film according to the invention.

FIG. 1 and FIG. 2 each show a detail of a multilayer film 1 according to the invention with electrically controllable optical properties. The multilayer film 1 is an electrochromic multilayer film that can be switched from a transparent, uncoloured state into a coloured state with a reduced degree of light transmission.

The multilayer film 1 is limited by a first carrier film 5 and a second carrier film 6. The carrier films 5, 6 are made of PET and have a thickness of, for example, 0.125 mm. The carrier films 5, 6 are provided with a coating made of ITO having a thickness of approximately 100 nm, which form a first planar electrode 3 and a second planar electrode 4. An active layer sequence 2 is arranged between the planar electrodes 3, 4. The layer sequence 2 is an electrochromic layer sequence and consists of an ion storage layer 2a, an electrolyte layer 2b and an electrochromic layer 5c. By means of a DC voltage applied to the planar electrodes 3, 4, ions can be excited to migrate from the ion storage layer 2a, through the electrolyte layer 5b and into the electrochromic layer 2c, and vice versa. The proportion of ions in the electrochromic layer 2c determines the optical properties thereof, in particular the degree of light transmission and the colour.

The planar electrodes 3, 4 are electrically contacted in a circumferential edge region. Along the circumferential edge region, adjacent to the side edge of the multilayer film 1, alternating contact regions B and contact regions B′ are arranged. The contact regions B are used for electrical contacting of the second planar electrode 4. There, the first carrier film 5, the first planar electrode 3 and the active layer sequence 2 are completely removed, such that the second planar electrode 4 is exposed. A current busbar 7.2 is arranged on the second planar electrode 4. The contact regions B′ are used for electrical contacting of the first planar electrode 3. There, the second carrier film 6, the second planar electrode 4 and the active layer sequence 2 are completely removed, such that the first planar electrode 3 is exposed. A current busbar 7.1 is arranged on the first planar electrode 3. The planar electrodes 7.1, 7.2 are designed as strips of a tinned copper film with a thickness of approximately 0.06 mm. The planar electrodes are designed to be connected to a DC voltage source via electrical cables, wherein the current busbars 7.1 are connected to one pole and the current busbars 7.2 are connected to the other pole of the voltage source.

A separate current busbar 7.2 is arranged in each contact region B. Likewise, in each contact region B′ a separate current busbar 7.1 is arranged. Along the circumferential edge region, the two planar electrodes 3, 4 are thus alternately electrically contacted in a meandering manner. The electrochromic multilayer films 1 exhibit comparatively slow switching behaviour. Due to the meander-like electrical contacting, a more rapid change of the optical properties can be achieved than if, for example, the first planar electrode 3 were only contacted along one side edge and the second planar electrode 4 along the opposite side edge.

The strip-like contact regions B, B′ are designed in the shape of an elongated hexagon and extend along the side edge to which they are adjacent.

FIG. 3 shows a further design of the multilayer film 1 according to the invention. In contrast to FIG. 1, the contact regions B, B′ are designed in the shape of an isosceles trapezoid. They are also adjacent to the side edge of the multilayer film 1, wherein the longer of the two base sides (base) coincide with the side edge. This design is preferred over that of FIG. 1 if the contact regions are adjacent to the side edge of the multilayer film 1, because it saves space.

FIG. 4 shows various designs of the contact region B and the cutting line S according to the invention, which is introduced into the first carrier film 5 in order to remove it. According to the invention, the contact region B is designed in the shape of a strip with tapered ends, which can be realised in different ways.

In the design shown in FIG. 4a, the contact region B is designed in the shape of an elongated hexagon. The cutting line S circumferentially surrounds the contact region B, and corresponds to the boundary line of the contact region B. The hexagonal shape is advantageous, because a substantially rectangular region is provided between the tapered ends, which is ideally suited for inserting the (typically rectangular-strip-shaped) current busbar 7.2 into the contact region B.

The tapered ends of the contact region B are each formed by two sections of the cutting line S, which touch at one point, namely at the end point of the tapered end. Such sections of the cutting line S enclose an angle a, which is preferably less than 90°.

In the design shown in FIG. 4b, the contact region B is also designed in the shape of an elongated hexagon. The cutting line S surrounds the contact region B circumferentially. It contains the boundary line of contact region B, but continues beyond the end points of the tapered ends. This makes it even easier to lift and peel off the first carrier film 5 in the contact region B.

The tapered ends of the contact region B are each formed by two sections of the cutting line S, which part at one point, namely at the end point of the tapered end. Each of the two sections of the cutting line S continues beyond the end point, as an extension of the corresponding section of the boundary line of the contact region B.

In the design shown in FIG. 4c, the contact region B is designed to be lens-shaped. Here as well, the cutting line S continues beyond the end point of the tapered ends, as an extension of the sections of the boundary line of the contact region B adjacent to the end point. Since the cutting line is curved, to determine the angle α, the tangents at the end point (point of intersection) are to be used.

In the design shown in FIG. 4d, the contact region B is designed in the shape of a trapezoid. In the design shown in FIG. 4e, the contact region B is designed in the shape of a parallelogram. In these designs as well, the cutting lines S may extend beyond the end points of the tapered ends if said end point is not on the side edge of the multilayer film 1.

The cutting lines shown illustrate the principle of the invention. If the contact region B is directly adjacent to a side edge of the multilayer film 1, such that a section of the boundary line of the contact region B coincides with a section of the side edge, then of course no cutting line is required in such section. In this case, shapes with straight lateral boundaries, such as the hexagonal shapes of FIGS. 4a, 4b, 4d and 4e, are preferred. In particular, one of the lateral boundaries (long sides of the hexagon or trapezoid or parallelogram, respectively) coincides with a section of the lateral edge of the multilayer film 1 and does not need to be cut out.

FIG. 5 shows as comparative examples various designs of the contact region B and the cutting line S, which are not according to the invention. They are not designed in the shape of a strip with tapered ends.

In the design shown in FIG. 5a, the contact region B is designed in the shape of a rectangle. The cutting line S surrounds the contact region B circumferentially; it corresponds to the boundary line of the contact region B.

In the design shown in FIG. 5b, the contact region B is also designed in the shape of a rectangle. The cutting line S continues beyond the corner at each corner as an extension of the two adjacent sides.

In the design shown in FIG. 5c, the contact region B is designed in the shape of an elongated octagon. In the design shown in FIG. 5d, the contact region B is designed in the shape of an ellipse. In the design shown in FIG. 5e, the contact region B is designed in the shape of a rectangle with rounded corners. In the design shown in FIG. 5f, the contact region B is designed in the shape of an oval, which can be understood as a rectangle with two semicircles attached to the opposite short sides.

FIG. 6 shows cross sections through the multilayer film 1 of FIG. 1 at various points in time during the production method of a contact region B. First, the multilayer film 1 is provided (FIG. 6a). This typically involves cutting a commercially purchased multilayer film to the desired dimensions for the application. Then, a cut S′ (along the cutting line S) is made in the first carrier film 5 in order to separate the region of the first carrier film 5 to be removed, which has the shape of the contact region B, from the surrounding regions of the first carrier film 5 (FIG. 6b). The cut S′ may optionally also pass through the first planar electrode 3, as shown.

The cut S′ is preferably created by means of laser radiation, which is focused on the first carrier film 5 and moved over the multilayer film 1 along the cutting line S by means of a laser scanner. For example, a CO₂ laser operated in pulsed mode with a wavelength of 10.6 μm may be used for this purpose.

After the region of the first carrier film 5 lying in the designated contact region B has been separated from the rest of the carrier film 5 by the circumferential cut S′, it is removed together with the region of the first planar electrode 3 adhering to it (FIG. 6c). For this purpose, one of the tapered ends is lifted, for example with a razor blade, and said region of the first carrier film 5 is peeled off starting from there.

It may happen that portions of the active layer sequence 2 also adhere to the removed region of the first carrier film 5. In most cases, however, at least a remainder of the active layer sequence 2 remains in the multilayer film 1, if not the entire layer sequence 2 (as shown). It is now necessary to clean the second planar electrode 4 in the contact region from such residues of the active layer sequence 2 (FIG. 6d). This is preferably performed by applying an organic solvent, for example ethanol, to the contact region b and acting upon it. The organic solvent, together with the residues of layer sequence 2, may then easily be wiped off with a lint-free cloth. The second planar electrode 4 is now exposed in the contact region B and the current busbar 7.2 may be attached to it in an electrically conductive manner, which is not shown. Commercially available grease solvents or surface cleaning agents, for example Loctite 7840, may also be used for cleaning.

The contact regions B′ of the first planar electrode are created in the same way, wherein the cut S′ is made into the second carrier film 6 instead of into the first carrier film 5.

FIG. 7 shows a cross section through a laminated pane with the multilayer film 1 of FIG. 1 according to the invention. The laminated pane is provided, for example, as a roof pane of a passenger vehicle, the light transmission of which can be electrically controlled in regions. The laminated pane comprises a first pane 12 (outer pane) and a second pane 13 (inner pane), which are connected to one another via an intermediate layer. The first pane 12 and the second pane 13 consist of soda lime glass, which can optionally be tinted. The first pane 12, for example, has a thickness of 2.1 mm, the second pane 13 has a thickness of 1.6 mm.

The intermediate layer comprises a total of three thermoplastic layers 14a, 3b, 3c which are each formed by a thermoplastic film having a thickness of 0.38 mm made of PVB. The first thermoplastic layer 14a is connected to the first pane 12, the second thermoplastic layer 14b is connected to the second pane 13. The third thermoplastic layer 14c located in between has a cutout in which a multilayer film 1 with electrically controllable optical properties is inserted substantially in a precise fit, i.e., approximately flush on all sides. The third thermoplastic layer 14c thus forms a kind of passe-partout or frame, as it were, for the multilayer film 1, which is approximately 0.3 mm thick and is thickened to approximately 0.4 mm in the edge region by the current busbars 7.1, 7.2 used for electrical contact. Thus, the multilayer film 1 is encapsulated all around in thermoplastic material and thus protected.

The laminated pane has a circumferential edge region that is provided with an opaque cover printing 15. Such cover printing 15 is typically formed from a black enamel. It is imprinted as printing ink with a black pigment and glass frits in a screen printing method and is burned into the pane surface. The cover printing 15 is applied, for example, on the interior-side surface of the first pane 12 and also on the interior-side surface of the second pane 13. The side edges of the multilayer film 1 and the contact regions B, B′ are concealed by such cover printing 15.

FIG. 8 shows a top view of a further design of the multilayer film 1 according to the invention. It has two contact regions B′ for the first planar electrode 3, which extend along a major portion of two opposite side edges of the multilayer film 1. There is also a contact region B for the second planar electrode 4, which extends parallel thereto and is centred between the two contact regions B′ (“centre conductor”). The contact region B is spaced from the side edges of the multilayer film 1. It is a particular advantage of the present invention that such contact regions can be realised without delamination effects when the carrier film is removed.

The connection designs shown are only to be understood as examples. In principle, any connection design may be realised. Thus, the individual contact regions B, B′ of FIG. 8 could be replaced by a plurality of contact regions B, B′ arranged alternately and linearly one behind the other could be replaced. Such design is shown in FIG. 9. Those contact regions B, B′ which are directly adjacent to the side edge of the multilayer film 1 are designed in the shape of a trapezoid. In this case, the base of the trapezoid together with the end points of the tapered ends are arranged on the side edge of the multilayer film 1. Those contact regions B, B′ which are spaced from the side edge of the multilayer film 1 (“centre conductor”) are designed in the shape of an elongated hexagon. This configuration has proven to be particularly advantageous.

Likewise, it is alternatively possible, for example, that a circumferential, meander-like contacting as in FIG. 1 additionally has a contacting line running centrally between two opposite side edges, which is preferably also formed by a plurality of contacting regions B, B′ arranged alternately and linearly one behind the other.

### EXAMPLES

Contact regions B with different shapes were created in electrochromic multilayer films 1. In this case, the contact regions B were not arranged adjacent to the side edge of the multilayer films 1, but were spaced from it. This situation is particularly challenging because, due to the fact that the region of the first carrier film 5 to be removed is completely surrounded by remaining regions of the carrier film 5, particularly strong forces act during removal and the risk of delamination effects occurring is particularly high.

The cut S′ was made into the first carrier film 5 with laser radiation, using a CO₂ laser with an emission wavelength of 10.6 μm with an output of approximately 11 W. The laser was operated in pulsed mode with a pulse frequency of 2000 Hz. The pulse length was in the range of 10 μs to 100 μs. The laser beam was moved at a speed of 4 m/s along the cutting line.

The region of the first carrier film 5 cut off by the cutting line S was subsequently peeled off with a razor blade starting from a tapered end. The result was then evaluated visually, wherein it was evaluated as positive if the region of the first carrier film 5 to be removed was completely separated and could be easily removed, and if the multilayer film 1 did not show signs of delamination due to peeling off (in particular, separation between the individual layers in the regions surrounding the contact region B).

The shape of the contact region B and the percentage of positive results for the examples and comparative examples can be seen in Table 1.

TABLE 1

| | Shape of the contact region | Positive results |
|---|---|---|
| Example 1 | FIG. 3a | 80% |
| Example 2 | FIG. 3b | 100% |
| Comparative example 1 | FIG. 4a | 33% |
| Comparative example 2 | FIG. 4b | 40% |
| Comparative example 3 | FIG. 4c | 40% |

It can be clearly seen that significantly improved results can be achieved by the shape of the contact region according to the invention. More than 50% rejects occurred in the comparative examples, while a high number of positive results were observed in the examples according to the invention. It is particularly advantageous if the cutting lines S extend beyond the end points of the tapered ends (Example 2).

### LIST OF REFERENCE SIGNS

(1) Multilayer film with electrically controllable optical properties
(2) Active layer sequence of the functional element 1
(2a) Ion storage layer of an electrochromic layer sequence 2′
(2b) Electrolyte layer of an electrochromic layer sequence 2′
(2c) Electrochromic layer of an electrochromic layer sequence 2′
(3) First planar electrode of the functional element 1
(4) Second planar electrode of the functional element 1
(5) First carrier film of the multilayer film 1
(6) Second carrier film of the multilayer film 1
(7.1) Current busbar of the first planar electrode 4
(7.2) Current busbar of the second planar electrode 4
(12) First pane
(13) Second pane
(14a) First thermoplastic connecting film
(14b) Second thermoplastic connecting film
(14c) Third thermoplastic connecting film
(15) Cover printing
(B) Contact region of the second planar electrode 4
(B′) Contact region of the first planar electrode 3
(S) Cutting line
(S′) Cut
(α) Angle between the sections of the boundary line of the contact region B adjacent to the end points of the tapered ends
X-X′ Cross section line

1.-15. (canceled)

16. A multilayer film having electrically controllable optical properties, comprising in the order specified and arranged one above the other in a flat manner:
a) a first carrier film,
b) a first planar electrode,
c) an active layer comprising one or more layers in sequence, the active layer having electrically controllable optical properties,
d) a second planar electrode and
e) a second carrier film,
wherein, in a first contact region, the first carrier film, the first planar electrode and the active layer are removed, such that the second planar electrode is exposed,
wherein the first contact region is in the shape of a strip with tapered ends.

17. The multilayer film according to claim 16, wherein the first contact region is in the shape of an elongated hexagon.

18. The multilayer film according to claim 16, wherein the first contact region is in the shape of a trapezoid.

19. The multilayer film according to claim 16, wherein the tapered ends are defined by two touching sections of a boundary line of the first contact region, which form an angle of less than 90°.

20. The multiplayer film according to claim 19, wherein the angle is greater than 50°.

21. The multilayer film according to claim 16, wherein the tapered ends are defined by two touching sections of a boundary line of the first contact region, further comprising a cut in at least the first carrier film, the cut extending from each of said sections and having a length of at least 1 mm.

22. The multilayer film according to claim 16, further comprising a current busbar arranged in the contact region on the second planar electrode, wherein the current busbar is a strip of an electrically conductive film.

23. The multilayer film according to claim 16, wherein, in a second contact region the second carrier film, the second planar electrode and the active layer are removed, such that the first planar electrode is exposed, wherein the second contact region is in the shape of a strip with tapered ends.

24. The multilayer film according to claim 16, wherein the multilayer film is an electrochromic multilayer film having electrochromic active layers, the electrochromic active layers comprising in the order specified and arranged one above the other in a flat manner:
c1) an ion storage layer,
c2) an electrolyte layer, and
c3) an electrochromic layer.

25. A laminated pane comprising two glass panes and a multilayer film according to claim 16, wherein the multilayer film is arranged between the two glass panes and is connected to each pane via at least one thermoplastic connecting film.

26. A method for producing a multilayer film having electrically controllable optical properties, the method comprising:
(A) providing a multilayer film having electrically controllable optical properties, the multilayer film comprising in the order specified and arranged one above the other in a flat manner:
a) a first carrier film,
b) a first planar electrode,
c) an active layer comprising one or more layers in sequence, the active layer having electrically controllable optical properties,
d) a second planar electrode and
e) a second carrier film,
(B) separating at least one region of the first carrier film from surrounding regions of the first carrier film by a cut, wherein the cut surrounds a contact region in the shape of a strip with tapered ends,
(C) peeling off said at least one region of the first carrier film together with a region of the first planar electrode adhering thereto, the peeling starting from one of the tapered ends, and
(D) cleaning the second planar electrode in the contact region of residue of the active layer.

27. The method according to claim 26, wherein the cut is created by radiation of a laser.

28. The method according to claim 27, wherein a wavelength of the radiation is from 3 μm to 50 μm.

29. The method according to claim 28, wherein the wavelength of the radiation is from 5 μm to 20 μm.

30. The method according to claim 27, wherein the radiation has an output of from 1 W to 50 W.

31. The method according to claim 30, wherein the output is from 5 W to 20 W.

32. The method according to claim 27, wherein the laser is operated in pulsed mode with a pulse frequency of 500 Hz to 5000 Hz and with a pulse length of 10 μs to 100 μs.

33. The method according to claim 32, wherein the pulse frequency is from 1000 Hz to 3000 Hz.

34. The method according to claim 26, wherein the residues of the active layer are removed with an organic solvent.
